(19) United States
(12) Patent Application Publication
(10) Pub. No.: US 2025/0267157 A1
(43) Pub. Date: Aug. 21, 2025

(54) DETERMINING SECURITY RISKS RELATED TO LOCAL ADMINISTRATOR RIGHTS ACTIVITY

(71) Applicant: Dell Products L.P., Round Rock, TX (US)

(72) Inventors: Vivek Bhargava, Bangalore (IN); Mayank Kapoor, Bangalore (IN); Furkan Mohd Nisar, Ambedkar Nagar (IN); Dinesh Koppada, Bengaluru (IN)

(21) Appl. No.: 18/583,189

(22) Filed: Feb. 21, 2024

(51) Int. Cl. H04L 9/40; G06N 20/00

(52) U.S. Cl. CPC H04L 63/1425; G06N 20/00; H04L 63/10

(57) ABSTRACT

Methods, apparatus, and processor-readable storage media for determining security risks related to local administrator rights (LAR) activity are provided herein. An example computer-implemented method includes obtaining data pertaining to one or more activities performed by at least one user acting in connection with at least one granted set of LAR; classifying the one or more activities into one or more security risk-based categories by processing at least a portion of the obtained data; determining one or more security-related recommendations based at least in part on the classifying of the one or more activities into the one or more security risk-based categories; and performing at least one automated action based at least in part on at least a portion of the one or more security-related recommendations.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In many contexts and/or situations, numerous actions commonly occur with respect to a system and/or network after the granting of local administrator rights (LAR) access to a corresponding user. However, using conventional LAR management techniques, activities performed by such a user are typically permitted and/or not monitored so long as the activities occur within the scope of the granted LAR access, which can result in security vulnerabilities, outages, resource wastage, etc.

### SUMMARY

Illustrative embodiments of the disclosure provide techniques for determining security risks related to LAR activity.

An exemplary computer-implemented method includes obtaining data pertaining to one or more activities performed by at least one user acting in connection with at least one granted set of LAR, and classifying the one or more activities into one or more security risk-based categories by processing at least a portion of the obtained data. Additionally, the method also includes determining one or more security-related recommendations based at least in part on the classifying of the one or more activities into the one or more security risk-based categories, and performing at least one automated action based at least in part on at least a portion of the one or more security-related recommendations.

Illustrative embodiments can provide significant advantages relative to conventional LAR management techniques. For example, problems associated with security vulnerabilities, outages and/or resource wastage are overcome in one or more embodiments through determining and automatically acting upon security risks related to LAR activity.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for determining security risks related to LAR activity in an illustrative embodiment.

FIG. 2 shows example pseudocode for querying event logs for particular events in an illustrative embodiment.

FIG. 3 shows example pseudocode for a sample data collection output in an illustrative embodiment.

FIG. 4 shows example pseudocode for samples of activity performed during elevated LAR access collected from different users in an illustrative embodiment.

FIG. 5 shows an example system diagram and workflow for determining security risks related to LAR activity in an illustrative embodiment.

FIG. 6 is a flow diagram of a process for determining security risks related to LAR activity in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

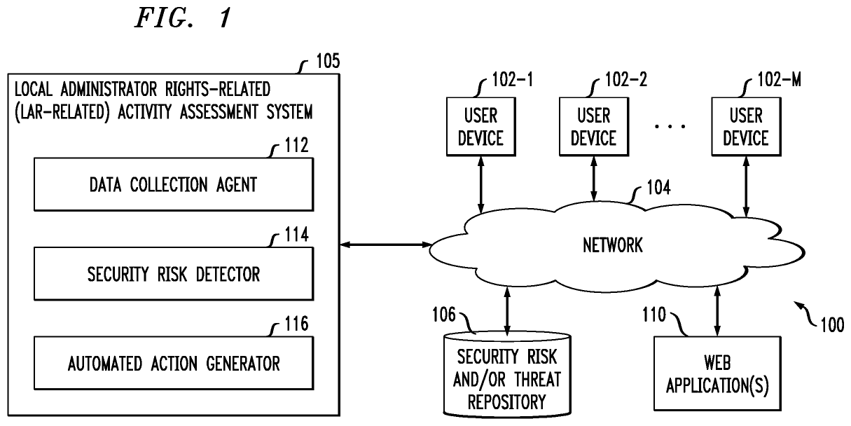

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is LAR-related activity assessment system 105 and one or more web applications 110 (e.g., one or more security-related applications, one or more trusted applications, one or more untrusted applications, one or more monitoring applications, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, LAR-related activity assessment system 105 can have an associated security risk and/or threat repository 106 configured to store data pertaining to user activities associated with various LAR access privileges, functional security requirements, non-functional requirements, activity data and corresponding triggered action data associated with various users, etc.

The security risk and/or threat repository 106 in the present embodiment is implemented using one or more storage systems associated with the LAR-related activity assessment system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the LAR-related activity assessment system 105 are one or more input-output devices, which illustratively comprise keyboards, displays or other types of input-output devices in any combination. Such input-output devices can be used, for example, to support one or more user interfaces to the LAR-related activity assessment system 105, as well as to support communication between the LAR-related activity assessment system 105 and other related systems and devices not explicitly shown.

Additionally, the LAR-related activity assessment system 105 in the FIG. 1 embodiment is assumed to be implemented using at least one processing device. Each such processing device generally comprises at least one processor and an associated memory, and implements one or more functional modules for controlling certain features of the LAR-related activity assessment system 105.

More particularly, the LAR-related activity assessment system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the LAR-related activity assessment system 105 to communicate over the network 104 with the user devices 102, and illustratively comprises one or more conventional transceivers.

The LAR-related activity assessment system 105 further comprises data collection agent 112, security risk detector 114, and automated action generator 116.

It is to be appreciated that this particular arrangement of elements 112, 114 and 116 illustrated in the LAR-related activity assessment system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for determining security risks related to LAR activity involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of LAR-related activity assessment system 105, security risk and/or threat repository 106, and web application(s) 110 can be on and/or part of the same processing platform.

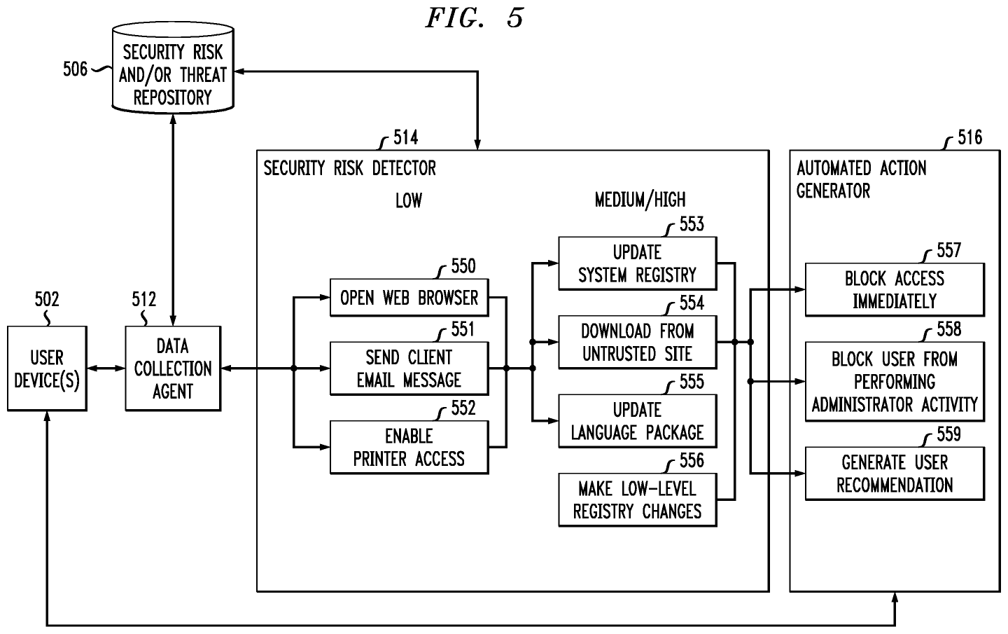

An exemplary process utilizing elements 112, 114 and 116 of an example LAR-related activity assessment system 105 in computer network 100 will be described in more detail with reference to the flow diagram of FIG. 6.

Accordingly, at least one embodiment includes determining security risks related to LAR activity. Such an embodiment includes monitoring user activities performed during times when the user has been granted certain LAR access. As further detailed herein, such an embodiment can include detecting one or more security risks and/or security threats which could lead to vulnerability to the corresponding device, system, and/or network. More particularly, at least one embodiment includes reducing and/or minimizing security risks when a given user has been granted LAR access and/or elevated LAR access, wherein such reducing and/or minimizing security risks can include, e.g., blocking certain actions, blocking malicious Wi-Fi packets, etc. Additionally or alternatively, one or more embodiments can include implementing an intelligent mechanism to communicate to the user upon detecting an activity which is non-compliant as per one or more enterprise and/or organization standards. Such an intelligent mechanism can be implemented to learn and/or understand how users typically behave and one or more security rules in place corresponding to such behavior. In an example embodiment, when such an intelligent mechanism identifies unusual behavior and/or behavior which violates one or more security rules, the intelligent mechanism can automatically generate and send a clear and personalized message to the corresponding user, suggesting one or more specific actions to fix and/or improve the issue. Further, in one or more embodiments, such an intelligent mechanism continues to learn over time and improves such communications based at least in part on user feedback, contextual information, user behavior, security policies, changing security threats, etc.

By way merely of illustration, in a context wherein a user has requested LAR access and/or elevated LAR access to install multiple applications on an enterprise device, there can be one or more security risks which arise while the user is performing various activities. Such activities may not be limited to the local environment of the user's device, but the activities can be performed and/or can initiate impacts across different infrastructure such as, for example, updating a package in a server, sharing files, navigating an internal website, etc. Accordingly, at least one embodiment includes collecting and/or obtaining event logs for LAR-related activity, and based at least in part on the processing of such logs, building and/or maintaining one or more security risk and/or threat repositories which can facilitate the identification of unusual user activities during periods of LAR access and/or elevated LAR access.

As noted above and further detailed herein, one or more embodiments include data collection during periods of LAR access and/or elevated LAR access. For example, such an embodiment can include collecting application names, from operating system (OS) logs, with respect to applications that were launched during a periods of LAR access and/or elevated LAR access.

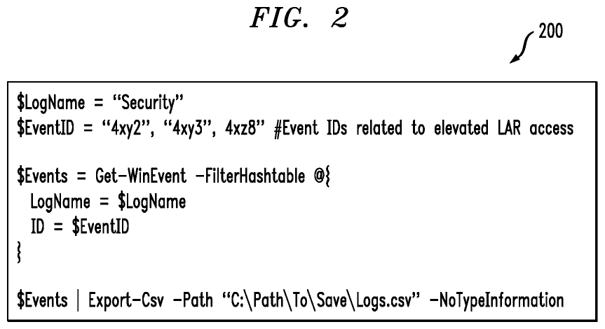

FIG. 2 shows example pseudocode for querying event logs for particular events in an illustrative embodiment. In this embodiment, example pseudocode 200 is executed by or under the control of at least one processing system and/or device. For example, the example pseudocode 200 may be viewed as comprising a portion of a software implementation of at least part of LAR-related activity assessment system 105 of the FIG. 1 embodiment.

The example pseudocode 200 illustrates setting the $LogName variable to “Security” to target the security log which contains the desired and/or relevant events. Also, example pseudocode 200 illustrates specifying the $EventID array variable with the relevant event identifiers (IDs) related to elevated LAR access. In one or more embodiments, the event IDs specified here can be added to and/or modified according to the requirements in question. Referring again to FIG. 2, example pseudocode 200 illustrates using a Get-WinEvent command to query the event log based on the specified log name and event IDs. The results are then stored in connection with the $Events variable. Finally, example pseudocode 200 illustrates exporting the collected events to a comma-separated values (CSV) file using an export-Csv command, specifying the desired file path with a “Path” parameter. As also depicted in example pseudocode 200, the “NoTypeInformation” parameter removes type information from the CSV file to keep the file clean. In one or more embodiments, type information refers to the data types of the properties and/or columns in an object. By using “NoTypeInformation,” such an embodiment can obtain a cleaner CSV file without header information, rendering the file more human-readable and suitable for sharing for further analysis. As such, the resulting CSV file will only contain the data, without metadata about the types of each column.

It is to be appreciated that this particular example pseudocode shows just one example implementation of querying event logs for particular events, and alternative implementations can be used in other embodiments.

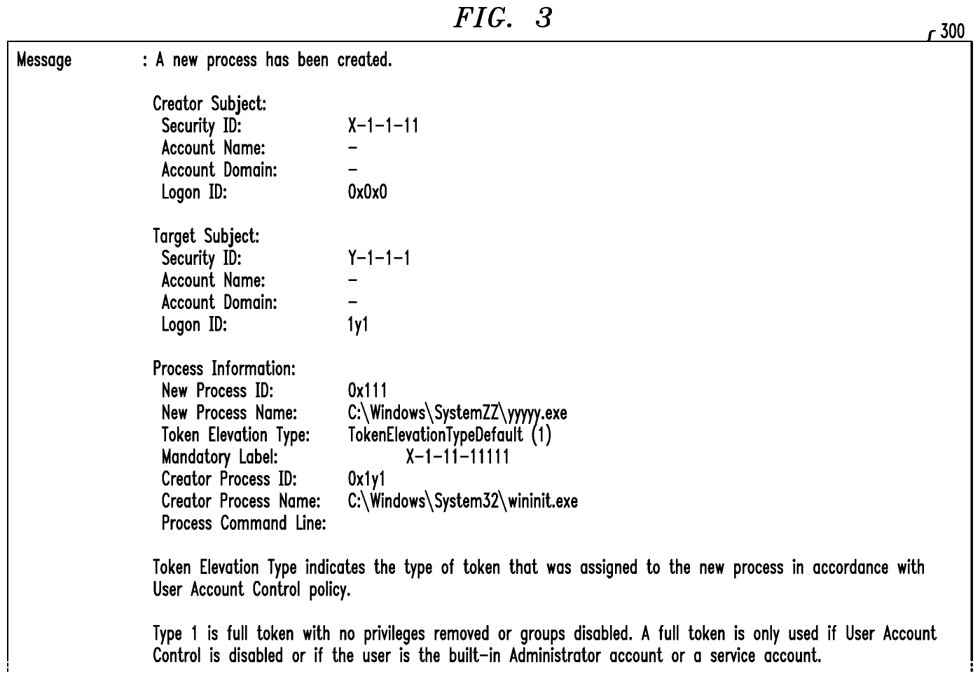

FIG. 3 shows example pseudocode for a sample data collection output in an illustrative embodiment. In this embodiment, example pseudocode 300 is executed by or under the control of at least one processing system and/or device. For example, the example pseudocode 300 may be viewed as comprising a portion of a software implementation of at least part of LAR-related activity assessment system 105 of the FIG. 1 embodiment.

The example pseudocode 300 illustrates information which helps to understand when and how a new process (e.g., yyyyy.exe in example pseudocode 300) was initiated, who initiated the process, and the context in which the process initiation occurred. Monitoring such events can be important for security analysis and detecting potentially malicious activities on a given system. More particularly, example pseudocode 300 signifies a new process creation. Specifically, event identifier (ID) 1111 is generated whenever a new process is created, and such an event falls under the “Security” category in an Event Viewer.

Example pseudocode 300 also includes information about the process such as, for example, new process name, new process path, creator process ID, creator process name, subject security ID, subject account name, time created, thread ID, record ID, etc. More specifically, a new process name indicates the name and path of the newly created process. Creator process ID represents the process ID (PID) of the process that created the new process, creator process represents the name of the process that created the new process. Subject security ID represents the security identifier (SID) of the account that initiated the process creation, and subject account name represents the name of the account that initiated the process creation. Also, time created timestamp indicates when the event was generated, thread ID represents the identifier of the thread that initiated the event, “record is” represents a unique identifier for the event record in the log, which can be useful, e.g., for tracking and/or referencing specific events.

It is to be appreciated that this particular example pseudocode shows just one example implementation of an example data collection output, and alternative implementations can be used in other embodiments.

As also detailed herein, one or more embodiments include building and/or maintaining one or more security risk and/or threat repositories. In such an embodiment, such a repository can be built and/or maintained as follows. For each relevant and/or designated type of user action, a state machine model is built from one or more functional security requirements. By way of example, one or more embodiments include employing a security risk and/or threat repository that is built around predefined user actions derived from functional requirements. Such actions can be designed based at least in part on what the given system needs to do and one or more potential risks involved. Also, such actions can be modeled using a state machine, and their associated security risks can be prioritized in at least one threat assessment diagram. Non-functional security aspects and threats can then be derived from at least a portion of these predefined requirements. Organization-specific policies can be applied to further narrow down options for users, and the culmination of such considerations results in possible user options, and one or more optimized suggestions are then presented to the user(s) based at least in part on one or more security and/or risk factors.

As noted, in at least one embodiment, functional security requirements can be ordered according to priority and modeled in the form of a threat assessment diagram. Also, based at least in part on the functional security requirements, one or more non-functional security risks and/or threats can be derived. By way merely of illustration, consider a functional security requirement in which users are allowed to install applications only from approved software repositories managed by the given organization. In such an example, the functional requirement emphasizes approved sources, and as such, a non-functional risk could include “Unauthorized Software Installation Risk,” wherein users might attempt to install applications from unapproved and/or potentially malicious sources. Also, a non-functional risk could include “Malware Injection Risk,” wherein malicious software is disguised as a legitimate application during the installation process. Further, a non-functional risk could include “License Compliance Risk,” wherein users install software without valid licenses, leading to compliance issues. Additionally, a non-functional risk could include “Data Privacy Risk,” wherein unauthorized applications may access and/or compromise sensitive user data.

Also, in at least one embodiment, one or more policy parameters (e.g., policy parameters specific to the organization or enterprise in question) are then applied on top of the functional and/or non-functional requirements to narrow down one or more further options. For example, consider a scenario wherein there exists an organization policy not to allow a user to make system registry changes when performing such activities will block the user from performing any additional and/or separate action. As used in this context, “options” refers to the actionable choices presented to users based on predefined user actions, security considerations, organizational policies, risk assessments, etc. Such options are designed to guide users toward secure and/or compliant actions, prioritizing such actions according to one or more associated security risks.

Further, such an embodiment includes ultimately determining the possible options that are available for the user with respect to a given action and/or activity. For example, such an embodiment can include determining and providing, to the given user, at least one suggestion (e.g., associated with the best or optimized option) based at least in part on the security risk level of the corresponding action and/or activity in question. Such a suggestion can include, e.g., requesting the user's consent to proceed with the given action and/or activity. Also, such suggestions can be provided to users based at least in part on security risk levels and/or other considerations, and the suggestions aim to guide users toward secure and/or compliant actions. Example suggestions might include, for instance, offering alternative actions with lower risks, recommending security best practices, aligning actions with organizational policies, providing educational information and/or user training, offering risk mitigation steps, issuing security alerts, seeking explicit user consent, encouraging user feedback, etc.

By way of example, an activity such as opening a web browser or sending a client email message can be associated with a low level of security risk, and an activity such as making low-level registry changes, making unapproved changes in a language package, or downloading content from an untrusted website can be associated with a medium level of security risk. Further, an activity such as starting a command prompt to run system commands, for a user who has no history of performing engineering-level activity, can be associated with a high level of security risk.

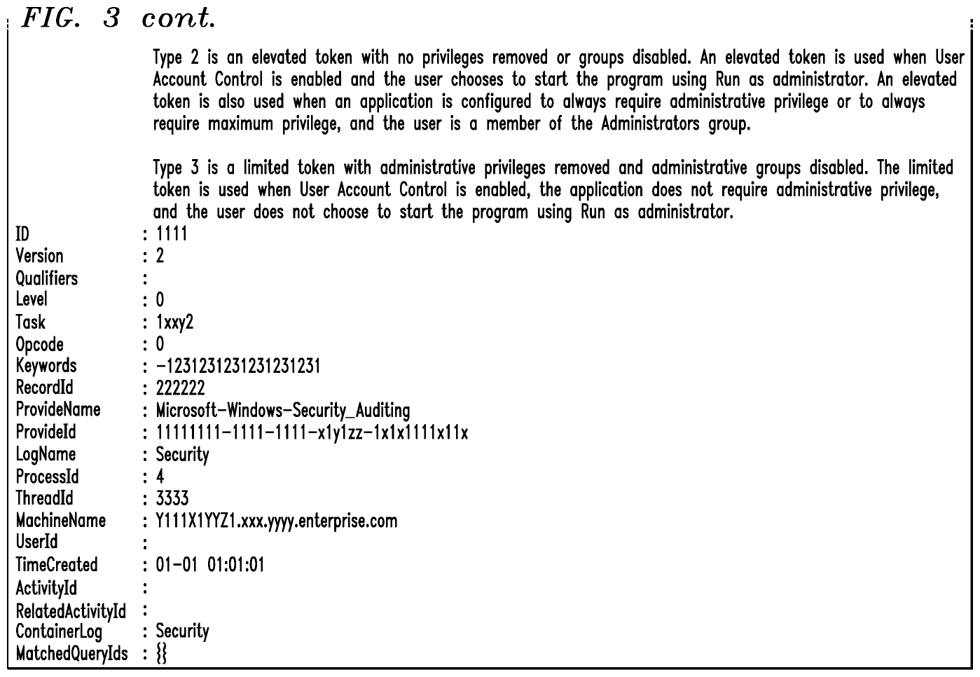

FIG. 4 shows example pseudocode for samples of activity performed during elevated LAR access collected from different users in an illustrative embodiment. In this embodiment, example pseudocode 400 is executed by or under the control of at least one processing system and/or device. For example, the example pseudocode 400 may be viewed as comprising a portion of a software implementation of at least part of LAR-related activity assessment system 105 of the FIG. 1 embodiment.

The example pseudocode 400 illustrates data which can be used in connection with categorizing various user activities based on their associated security risks. Such categorizations can be subjective and may vary depending on the specific criteria and/or risk assessment associated with a given organization. That said, categorized risk levels can help prioritize security concerns, for example, with low-risk activities considered safe, medium-risk activities potentially requiring attention, and high-risk activities raising significant security concerns.

It is to be appreciated that this particular example pseudocode shows just one example implementation of activity performed during elevated LAR access collected from different users, and alternative implementations can be used in other embodiments.

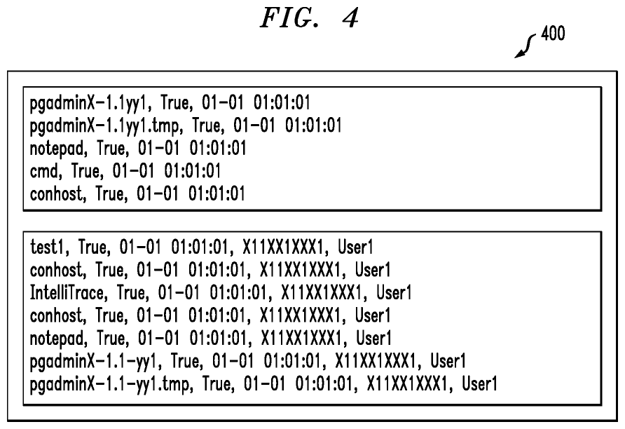

FIG. 5 shows an example system diagram and workflow for determining security risks related to LAR activity in an illustrative embodiment. By way of illustration, FIG. 5 depicts data collection agent 512, which collects data from one or more user devices 502 (e.g., one or more user devices associated with a given user who has been granted LAR access and/or elevated LAR access). By way merely of example, a customer premise equipment (CPE) can act as a data collection agent, facilitating the learning of the corresponding user's/customer's needs and/or behavior.

In one or more embodiments, data collection agent 512 collects one or more metrics, ensuring confidentiality of the data, and abstracts one or more portions of the collected information. Such metrics can include, e.g., risk assessment accuracy, policy compliance rates, etc. Metrics can be used, for example, to help assess accuracy in risk assessments and/or adherence to organizational policies, and to drive iterative improvements in a security risk and/or threat repository.

At least a portion of the collected and/or abstracted data can then be provided by the data collection agent 512 to security risk and/or threat repository 506, and at least a portion of the collected and/or abstracted data can be provided by the data collection agent 512 to security risk detector 514 for analysis and/or processing.

Such an embodiment also includes performing, using security risk detector 514, user intent-based reprovisioning by leveraging metadata defined in one or more designated systems (e.g., one or more expert-related systems) and/or derived from the security risk and/or threat repository 506, as well as at least a portion of the data collected from one or more applications by the data collection agent 512. Metadata such as noted above can include, by way of example, information detailing user actions (such as applications used, commands executed, tasks performed, etc.), data about the configuration settings of user systems (including preferences, installed applications, system settings, etc.), details on how frequently and in what manner users interact with different applications within systems, information related to security policies, vulnerabilities, and measures stored in security risk and/or threat repository (including, e.g., data on identified threats and their severity), patterns and/or triggers identified by monitoring similar entities, users, and/or other deployments, and updates in metadata related to security and/or risk expertise (which can include, e.g., information on newly discovered vulnerabilities, security threats, and measures to address them).

As noted above and further detailed herein, user reprovisioning can include continuously monitoring user activities. Suppose by way of example, that an observation is made that a given user has started frequently using a specific software tool for project management (e.g., opening a web browser, downloading files, and accessing project-related tools). Based on the observed pattern(s), at least one embodiment can include suggesting reprovisioning, which might include, for example, recommending the granting of additional access. Alternatively, if unusual and/or high risk user behavior is detected, such as, e.g., attempting low-level system commands without a history of engineering-level activities, such an embodiment can include suggesting reprovisioning by restricting user access and/or triggering a security alert. Further, in one or more embodiments, data collection agent 512 can be configured to collect information through one or more application programming interfaces (APIs) provided by one or more systems. Based at least in part on such collected information, user reprovisioning can be carried out as follows.

Activities performed by one or more similar entities (e.g., friends, co-workers, other deployments, etc.) to the user in question are monitored and one or more patterns that trigger one or more common actions (e.g., open a web browser, download files, accessing specific tools, performing configuration changes, etc.) are identified. By monitoring similar entities and identifying patterns of common actions, one or more insights can be gained into typical and/or relevant user behaviors. Such patterns can help inform decisions related to user access privileges, security policies, workflow optimization, etc.

Additionally, data pertaining to activities performed by the user can be extracted from the local device (e.g., user device 502) in connection with data collection agent 512, and used to determine one or more potential options that can be based and/or selected at least in part by the current state of the user (e.g., the present condition of the user within the system, which can include various aspects of the user's interactions, behaviors, activity logs, system configurations, application usage information, etc.).

For example, one or more embodiments can include extracting relevant data from the user's local device such as user activity logs, system configurations, application usage information, etc. Such data can provide insights into the current state of the user. Such an embodiment can also include storing at least a portion of such data into and leveraging a security risk and/or threat repository 506, which can contain diagrams and/or models representing expert knowledge and expertise related to user provisioning and access management. More particularly, such an embodiment can include monitoring changes in the metadata uploaded to the security risk and/or threat repository 506, potentially triggering reevaluation of the options and/or automatic actions generated and/or suggested for the user in connection with automated action generator 516.

By monitoring changes in the metadata uploaded to the security risk and/or threat repository 506, such an embodiment includes ensuring that the options and/or recommendations provided to the user remain relevant and effective. By way merely of example, if a change indicative of a newly discovered vulnerability is detected, this can trigger a reevaluation of options, and updated measures to address the security threat in a timely manner can be suggested and/or initiated. Additionally, at least one embodiment can include ranking the options and/or recommendations based at least in part on the net benefit(s) corresponding therewith, and optionally requesting user consent to proceed with at least one of the options and/or recommendations. By way merely of example, consider a scenario wherein a newly discovered vulnerability is detected, triggering a reevaluation of options, and an updating of proposed measures to address the security threat in a timely manner.

Based at least in part on the user consent and the degree of detail to be shared, such an embodiment can include initiating one or more conversations with at least one domain expert and/or initiating one or more automated actions. By way of example, consider a scenario wherein at least one embodiment includes improving and/or optimizing user LAR access privileges for enhanced security management. Such an embodiment can include identifying multiple potential suggestions based at least in part on the user's activities and one or more security policies. More particularly, such an embodiment can include generating suggestions based at least in part on the net benefits offered by each suggestion.

For example, a first suggestion can include granting LAR to a user who frequently performs system configuration tasks, as it would enhance the user's productivity and efficiency. Another suggestion can include revoking LAR for a user who rarely requires elevated privileges, reducing the risk of unauthorized access and potential security breaches. Further, yet another suggestion can include implementing multi-factor authentication (MFA) for a user with sensitive data access to enhance security without altering the user's existing LAR privileges. Based at least in part on the user's consent and the degree of details to be shared, at least one embodiment can include initiating one or more actions in connection with one or more of the suggestions. For example, if the user requests more information and/or wants to consult with a domain expert, such an embodiment includes initiating a conversation with the domain expert to address concerns and/or questions, and making any necessary modifications based thereon (e.g., adjusting user LAR access privileges, implementing recommended security measures, etc.).

Referring again to FIG. 5, security risk detector 514 can process data obtained and/or provided by data collection agent 512 and classify the user activities related to such data into multiple categories associated with risk level. For example, security risk detector 514 can classify data pertaining to activities including opening a web browser 550, sending a client email message 551, and enabling printer access 552 into a low risk level category. Also, security risk detector 514 can classify data pertaining to activities including updating a system registry 553, downloading from an untrusted website 554, updating a language package 555, and making low-level registry changes 556 into a medium and/or high risk level category. Further, while certain activities (e.g., activities classified into the low risk level category) may not trigger an action, in one or more embodiments, other activities (e.g., activities classified into the medium and/or high risk level category) can trigger interaction with automated action generator 516 to facilitate one or more corresponding actions.

As depicted in FIG. 5, data associated with a particular activity classified by security risk detector 514 can be provided to and/or processed by automated action generator 516 to determine one or more corresponding and/or appropriate actions to be initiated and/or carried out. By way of example, data associated with the activity of making low-level registry changes 556 can trigger the automated action generator 516 to initiate the (immediate) blocking of user access to the registry 557. By way of additional example, data associated with the activity of downloading from an untrusted website 554 can trigger the automated action generator 516 to initiate the blocking of the user from performing administrator activity 558. Further, for example, data associated with the activity of updating a system registry 553 can trigger the automated action generator 516 to initiate the generation and/or transmission of a user recommendation 559 regarding such activities.

As detailed herein, one or more embodiments include monitoring and blocking user activity while the user is in an LAR status and/or an elevated LAR status. For example, when a user with LAR inadvertently attempts to install unauthorized software packages, such an embodiment includes actively monitoring for such activities. Using one or more detection techniques such as, e.g., behavioral analysis and/or real-time scanning, such an embodiment includes identifying and flagging suspicious and/or potentially malicious activity. By leveraging a security risk and/or threat repository, such an embodiment can include recognizing unauthorized software installations and preventing the execution of such software. Such prompt action can effectively safeguard one or more user devices and/or corresponding networks from potential harm, including, e.g., malware infections, system vulnerabilities, and/or unauthorized access. Also, one or more embodiments can include providing notifications and/or alerts to one or more users (e.g., administrators), enabling such users to take further action, if necessary (such as, for example, investigating an incident, providing user guidance on authorized software installations, etc.).

Additionally, one or more embodiments include recognizing one or more threats on a network that a given user and/or user device is connected to (e.g., detecting a proxy network, detecting how many other devices are connected in the same network, etc.). Also, in at least one embodiment, an outlier detection model is implemented to categorize user activities into risk classifications (e.g., high risk, medium risk, and low risk categories) based at least in part on functional and non-functional requirements. Such an embodiment includes leveraging one or more machine learning algorithms and historical data to establish patterns of normal and/or expected behavior for each type of persona or team, enabling identification of deviations that may indicate potential security risks and/or policy violations.

Such machine learning algorithms can include, for example, one or more anomaly detection algorithms, which can identify unusual patterns and/or behaviors in real-time data, making them suitable for detecting suspicious activities during software installations. By way of illustration, consider a scenario wherein a user with LAR attempts to install unauthorized software. In at least one embodiment an anomaly detection algorithm can be implemented to detect an unusually short duration and atypical sequence of system calls during the software installation, flagging it as a potential anomaly.

Additionally or alternatively, such machine learning algorithms can include, for example, one or more pattern recognition algorithms (such as, e.g., one or more random forest algorithms), which can be trained, e.g., on threat intelligence data to accurately recognize patterns associated with unauthorized software. By way of illustration, consider a scenario wherein, by training on historical data, a random forest model learns patterns associated with known unauthorized software, enabling accurate recognition and prevention of similar installations.

By way of further example, such machine learning algorithms can include one or more clustering algorithms, which can identify groups of normal behavior and detect outliers, helping categorize user activities into risk categories. By way of illustration, consider a scenario wherein a clustering algorithm categorizes certain user activities into high risk, medium risk, and low risk categories based at least in part on deviations from established patterns in historical data.

Similarly, in an enterprise environment, an outlier detection model can be employed to categorize user activities into risk-related categories, specifically considering the actions performed by users with LAR. Such a model can take into account functional and non-functional requirements and apply a contextual approach to risk assessment based at least in part on the user's persona and/or team. For instance, consider the actions of a programmer who possesses LAR access. Opening a command prompt and performing low-level system operations (e.g., executing scripts, debugging code, etc.) are common day-to-day activities for programmers, and as such, these types of actions would be categorized as low risk for the programmer persona because such actions are part of the user's regular responsibilities and align with the user's functional requirements. On the other hand, the same actions of opening a command prompt and performing low-level system operations can be classified as high risk for a non-technical sales and marketing professional. Because such individuals typically do not require LAR for their daily tasks, such activities might indicate potential misuse and/or unauthorized access. Therefore, an outlier detection model can be used to flag such actions as high risk for non-technical personas.

In one or more embodiments, OS logs can be used to monitor and classify user activities. Additionally, using metadata from various data sources to build and/or maintain a security risk and/or threat repository which can be utilized in conjunction with a data collection agent. Further, classification of user activity can be used to improve enterprise policy enforcement and/or improve enterprise security management.

FIG. 6 is a flow diagram of a process for determining security risks related to LAR activity in an illustrative embodiment. It is to be understood that this particular process is only an example, and additional or alternative processes can be carried out in other embodiments.

In this embodiment, the process includes steps 600 through 606. These steps are assumed to be performed by the LAR-related activity assessment system 105 utilizing elements 112, 114 and 116.

Step 600 includes obtaining data pertaining to one or more activities performed by at least one user acting in connection with at least one granted set of LAR. In at least one embodiment, obtaining data pertaining to one or more activities performed by the at least one user acting in connection with at least one granted set of LAR includes obtaining one or more of application usage information, operating system logs, user activity logs, and system configuration data. Additionally or alternatively, obtaining data pertaining to one or more activities performed by the at least one user acting in connection with at least one granted set of LAR can include querying one or more event logs for data associated with one or more particular events.

Step 602 includes classifying the one or more activities into one or more security risk-based categories by processing at least a portion of the obtained data. In one or more embodiments, classifying the one or more activities into one or more security risk-based categories includes processing at least a portion of the obtained data using at least one machine learning-based outlier detection model. Such an embodiment can also include training the at least one machine learning-based outlier detection model using data pertaining to one or more functional security-related requirements, data pertaining to one or more non-functional security-related requirements, and historical data associated with activities performed by one or more additional users relevant to the at least one user. Further, in such an embodiment, performing at least one automated action (such as detailed in connection with step 606) can include re-training the at least one machine learning-based outlier detection model based at least in part on feedback related to the at least a portion of the one or more security-related recommendations.

Step 604 includes determining one or more security-related recommendations based at least in part on the classifying of the one or more activities into the one or more security risk-based categories. In at least one embodiment, determining one or more security-related recommendations includes processing the at least a portion of the obtained data in conjunction with historical data associated with actions performed in response to one or more activities classified into the one or more security risk-based categories. Additionally or alternatively, determining one or more security-related recommendations can include ranking the one or more security-related recommendations based at least in part on a predicted security-related benefit corresponding with each of the one or more security-related recommendations.

Step 606 includes performing at least one automated action based at least in part on at least a portion of the one or more security-related recommendations. In one or more embodiments, performing at least one automated action includes automatically initiating at least one of blocking one or more predefined user actions, blocking one or more device transmission packets, adjusting one or more LAR access privileges within the at least one set of LAR granted to the at least one user, and implementing one or more additional security measures, separate from the at least one granted set of LAR, with respect to the at least one user.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to determine and automatically act upon security risks related to LAR activity. These and other embodiments can effectively overcome problems associated with security vulnerabilities, outages and/or resource wastage.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

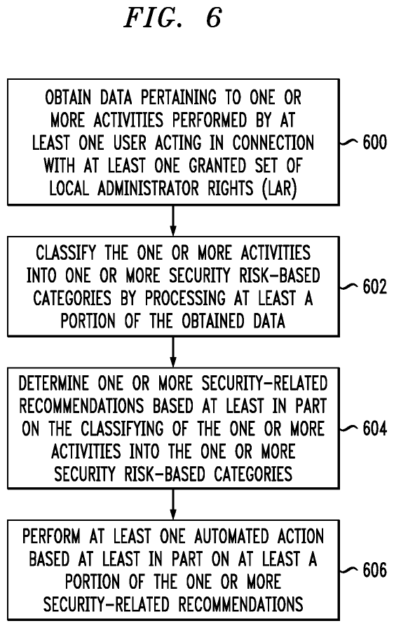

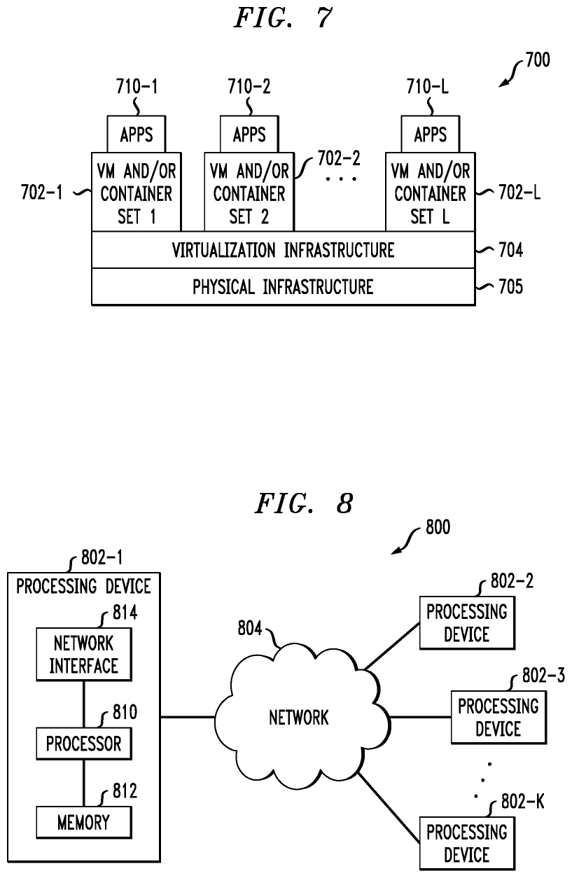

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a CPU, a GPU, a TPU, a microcontroller, an ASIC, a FPGA or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be 10 viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to one or more activities performed by at least one user acting in connection with at least one granted set of local administrator rights (LAR);
classifying the one or more activities into one or more security risk-based categories by processing at least a portion of the obtained data;
determining one or more security-related recommendations based at least in part on the classifying of the one or more activities into the one or more security risk-based categories; and
performing at least one automated action based at least in part on at least a portion of the one or more security-related recommendations;
wherein the method is performed by at least one processing device comprising a processor coupled to a memory.

2. The computer-implemented method of claim 1, wherein classifying the one or more activities into one or more security risk-based categories comprises processing at least a portion of the obtained data using at least one machine learning-based outlier detection model.

3. The computer-implemented method of claim 2, further comprising:
training the at least one machine learning-based outlier detection model using data pertaining to one or more functional security-related requirements, data pertaining to one or more non-functional security-related requirements, and historical data associated with activities performed by one or more additional users relevant to the at least one user.

4. The computer-implemented method of claim 3, wherein performing at least one automated action comprises re-training the at least one machine learning-based outlier detection model based at least in part on feedback related to the at least a portion of the one or more security-related recommendations.

5. The computer-implemented method of claim 1, wherein determining one or more security-related recommendations comprises processing the at least a portion of the obtained data in conjunction with historical data associated with actions performed in response to one or more activities classified into the one or more security risk-based categories.

6. The computer-implemented method of claim 1, wherein determining one or more security-related recommendations comprises ranking the one or more security-related recommendations based at least in part on a predicted security-related benefit corresponding with each of the one or more security-related recommendations.

7. The computer-implemented method of claim 1, wherein obtaining data pertaining to one or more activities performed by the at least one user acting in connection with at least one granted set of LAR comprises obtaining one or more of application usage information, operating system logs, user activity logs, and system configuration data.

8. The computer-implemented method of claim 1, wherein obtaining data pertaining to one or more activities performed by the at least one user acting in connection with at least one granted set of LAR comprises querying one or more event logs for data associated with one or more particular events.

9. The computer-implemented method of claim 1, wherein performing at least one automated action comprises automatically initiating at least one of blocking one or more predefined user actions, blocking one or more device transmission packets, adjusting one or more LAR access privileges within the at least one set of LAR granted to the at least one user, and implementing one or more additional security measures, separate from the at least one granted set of LAR, with respect to the at least one user.

10. A non-transitory processor-readable storage medium having stored therein program code of one or more software programs, wherein the program code when executed by at least one processing device causes the at least one processing device:
to obtain data pertaining to one or more activities performed by at least one user acting in connection with at least one granted set of local administrator rights (LAR);
to classify the one or more activities into one or more security risk-based categories by processing at least a portion of the obtained data;
to determine one or more security-related recommendations based at least in part on the classifying of the one or more activities into the one or more security risk-based categories; and
to perform at least one automated action based at least in part on at least a portion of the one or more security-related recommendations.

11. The non-transitory processor-readable storage medium of claim 10, wherein classifying the one or more activities into one or more security risk-based categories comprises processing at least a portion of the obtained data using at least one machine learning-based outlier detection model.

12. The non-transitory processor-readable storage medium of claim 11, wherein the program code when executed by the at least one processing device causes the at least one processing device:
to train the at least one machine learning-based outlier detection model using data pertaining to one or more functional security-related requirements, data pertaining to one or more non-functional security-related requirements, and historical data associated with activities performed by one or more additional users relevant to the at least one user.

13. The non-transitory processor-readable storage medium of claim 10, wherein determining one or more security-related recommendations comprises processing the at least a portion of the obtained data in conjunction with historical data associated with actions performed in response to one or more activities classified into the one or more security risk-based categories.

14. The non-transitory processor-readable storage medium of claim 10, wherein obtaining data pertaining to one or more activities performed by the at least one user acting in connection with at least one granted set of LAR comprises obtaining one or more of application usage information, operating system logs, user activity logs, and system configuration data.

15. The non-transitory processor-readable storage medium of claim 10, wherein performing at least one automated action comprises automatically initiating at least one of blocking one or more predefined user actions, blocking one or more device transmission packets, adjusting one or more LAR access privileges within the at least one set of LAR granted to the at least one user, and implementing one or more additional security measures, separate from the at least one granted set of LAR, with respect to the at least one user.

16. An apparatus comprising:
at least one processing device comprising a processor coupled to a memory;
the at least one processing device being configured:
to obtain data pertaining to one or more activities performed by at least one user acting in connection with at least one granted set of local administrator rights (LAR);
to classify the one or more activities into one or more security risk-based categories by processing at least a portion of the obtained data;
to determine one or more security-related recommendations based at least in part on the classifying of the one or more activities into the one or more security risk-based categories; and
to perform at least one automated action based at least in part on at least a portion of the one or more security-related recommendations.

17. The apparatus of claim 16, wherein classifying the one or more activities into one or more security risk-based categories comprises processing at least a portion of the obtained data using at least one machine learning-based outlier detection model.

18. The apparatus of claim 17, wherein the at least one processing device is further configured:
to train the at least one machine learning-based outlier detection model using data pertaining to one or more functional security-related requirements, data pertaining to one or more non-functional security-related requirements, and historical data associated with activities performed by one or more additional users relevant to the at least one user.

19. The apparatus of claim 16, wherein determining one or more security-related recommendations comprises processing the at least a portion of the obtained data in conjunction with historical data associated with actions performed in response to one or more activities classified into the one or more security risk-based categories.

20. The apparatus of claim 16, wherein obtaining data pertaining to one or more activities performed by the at least one user acting in connection with at least one granted set of LAR comprises obtaining one or more of application usage information, operating system logs, user activity logs, and system configuration data.
